(19) United States
(12) Patent Application Publication
(10) Pub. No.: US 2025/0170015 A1
(43) Pub. Date: May 29, 2025

(54) A VIBRATION TYPE MASSAGE DEVICE (VARIANTS)

(71) Applicants: Volodymyr KIREIEV, Kyiv (UA); Kostiantyn AKYNIN, Kyiv (UA); Oleksandr ANTONOV, Kyiv (UA)

(72) Inventors: Volodymyr KIREIEV, Kyiv (UA); Kostiantyn AKYNIN, Kyiv (UA); Oleksandr ANTONOV, Kyiv (UA)

(21) Appl. No.: 18/837,591

(22) PCT Filed: Feb. 7, 2023
(86) PCT No.: PCT/UA2023/000005

§ 371 Date: Aug. 10, 2024

(30) Foreign Application Priority Data
Feb. 10, 2022 (UA) A 2022 00600

(51) Int. Cl. A61H 23/02; A61H 15/00

(52) U.S. Cl. CPC A61H 23/0218; A61H 15/0078; A61H 2015/0042; A61H 2015/0071; A61H 2201/5005

(57) ABSTRACT

The invention (variants thereof) relates to a cosmetic technique field, in particular, to vibration type massage devices for providing a mechanical impact onto a human body in order to achieve a cosmetic or therapeutic effect, and it may be used at home or in equipping massage rooms. The proposed technical solution enables to provide the structurally simple, reliable, ergonomic vibration type massage device that is configured to select the operation mode and that provides a contactless control of parameters of oscillations of shafts without using any mechanical limiters, thereby achieving a smoothness and noiseless of its operation. Therewith, owing to an interaction between magnets which are arraned on the shafts, magnets which are arranged on an inner surface of a housing and coils which current impulses from an inverter are supplied to, periodic forces are formed on massage elements, and the periodic forces, in a single period of oscillations, smoothly rise, reach a maximum value and smoothly drop, and they may be adjusted depending on individual features of a human, while there is completely no negative vibration influence onto an operator's wrist and impact loads, and they avoid an uncontrolled circular rotation of the shafts, while at the same time, an operation efficiency of the claimed device is increased significantly.

### FIELD OF THE INVENTION

The invention relates to a cosmetic technique field, in particular, to vibration type massage devices for providing a mechanical impact onto a human body in order to achieve a cosmetic or therapeutic effect, and it may be used at home or in equipping massage rooms.

### PRIOR ART

A vibration type massage or vibromassage is a popular and well-known massage procedure that has been being used for many centuries so far. Initially, it had been done by hands and legs of a massage therapist, but after electricity was discovered in XIX century, a first special vibromassage device was invented.

During the procedure, the vibromassage device transmits oscillatory movements having different amplitudes and frequencies to tissues, and impulses act both on skin top layers and subcutaneous tissues, stimulate a blood and lymph circulation, facilitate a fat layer breakdown, relieve a tension and painful feelings in muscles, as well as facilitate a skin cleansing. The vibromassage facilitates a body improvement in case of an intestine dyskinesia or a metabolic disorder. A reflex action of the impulses improves health and relieves pain in case of osteochondrosis and radiculitis, eliminates stagnations in pelvic organs and in a lumbosacral spine region in case of a sedentary lifestyle. Owing to its unique properties, the vibromassage is also recommended to provide a prophylaxis of varicose veins and chronic venous insufficiency, to treat edemas and various nervous diseases.

Therewith, an apparatus vibromassage that includes use of massage devices is much more effective than manual massage techniques in view of affecting deep tissues which is not possible during the manual procedure, as well as in view of a longer influence onto the human body with the same intensity, since any device operates at a given frequency and amplitude until it is turned off.

Despite a number of the above-mentioned advantages of the vibromassage, the operation of most currently known vibromassage devices is based on using a traditional electric drive in combination with various electromagnetic, magneto-electric, mechanical motion converters, thereby creating significant impact forces when using such vibromassage devices and may cause unpleasant painful feelings or even an injure in a human. Furthermore, these vibromassage devices are characterized by noisy operation, significant weight and significant vibration of a housing of the massage device that is transmitted to an operator's hand. All these factors affect an ergonomics of the massage device and complicate its general use.

A prior art teaches a wide range of vibration type massage devices, and the applicant has selected several technical solutions among them, which are the closest to the proposed invention in terms of a set of essential features.

A patent U.S. Pat. No. 7,335,170 B2 dated Feb. 26, 2008 teaches a hand-held therapeutic device for relieving pain and providing a curative healing effect comprising an electric motor for rotating one or more permanent magnets or electromagnets to generate a magnetic field, micro-vibrations and acoustic tones; a shaft that connects one or more permanent magnets or electromagnets to the motor, wherein one or more permanent magnets or electromagnets are connected by the shaft in an offset manner such that one or more permanent magnets or electromagnets may rotate along a circular path with a center that is not arranged on an axial line of the shaft, and said permanent magnets or electromagnets are spaced unevenly about a circle of rotation, thereby creating oscillating inertial loads which are perceived by human sense organs as micro-vibrations which are transmitted to those portion of a human body that is contacted by a housing of said therapeutic device. A drawback of the proposed technical solution is that the structure of the therapeutic device utilizes the electric motor with an imbalance on the shaft that is characterized by noisy operation and causes tangible impact forces with some types of injuring events when the device housing contacts the human body surface, as well as by that the operator's hand perceives vibrations that come from the device housing, thereby causing a discomfort and a rapid fatigue of the operator during use of the device.

An application US2021307998 A1 dated Oct. 7, 2021 teaches a hand-held massager comprising a lower handle having a proximal end and a distal end, a curved upper handle having having a proximal end and a distal end, an articulating head positioned between the distal end of the lower handle and the distal end of the upper handle, and a massage nozzle that is secured to the articulating head and configured to adjust an arrangement angle of the massage nozzle relative to the lower and upper handles. Therewith, the articulating head comprises an electric motor and a drive assembly that actuates the massage nozzle by means of a vibrating arm and a shaft. During activation, a rotational motion from the electric motor is converted by a crank into a linear motion and transmitted via a piston connected to the shaft, and the shaft extends from the vibrating arm and coupled to the massage nozzle. A drawback of the proposed technical solution is that during actuation of the hand-held massager, weights of the massage nozzle and of the shaft create a significant vibration due to a return that is caused by a sudden direction change that may cause a fatigue of an operator's wrists and forearm, as well as makes a long-term use of the device impossible. In order to reduce the vibration acting on the user, said technical solution proposes to use a rubber sleeve that is inserted into an outer diameter of the vibrating arm, the sleeve at least partially absorbs the vibration and may consist of one or more components such as a silicone, a thermoplastic elastomer or an ethylene propylene diene monomer, however, the use of the rubber sleeve is not sufficiently effective and could not completely neutralize a negative impact that is made by the vibration load onto the user's wrist, and the rubber material is short-lived, is prone to deformations and abrasion, as well as requires a frequent replacement.

A patent TWI702041 B dated Aug. 21, 2020 teaches a head massaging device comprising a knob having a tubular element that is arranged in its top portion and has a cavity that is open through a top portion of the tubular element, and a needle that extends from an inner lower portion of the tubular element, the inner lower portion is provided with a plurality of openings. The knob is connected to a handle with a switch-controlled vibration motor inserted thereto. A magnetic element having protrusions for the head massaging is connected to the lower portion of the knob and provided with a plurality of openings which are arranged on the corresponding protrusions. A liquid container is inserted into the tubular element, and the liquid, after the needle has penetrated into a container bottom, flows through a tube that is arranged within the cavity in the lower portion of the knob over the magnetic element to the protrusions of the magnetic element which massage the user's head. Oil, cream or medicines may be used as the liquid depending on needs and objective. According to the invention, the magnetic element generates a magnetic energy in order to adjust a magnetic field of the human head, and by means of the liquids, magnetic energy and the head vibromassage, a nervous system is activated and cerebral cortex functions are regulated. A drawback of the proposed technical solution lies in that its usage is limited by the head vibromassage only, as well as in that the vibration motor is arranged inside the handle of the proposed device, thereby causing vibration loads onto the operator's wrist and forearm via the device's handle, creating a notable noise level, as well as causing notable impact loads onto areas of the human body which the massage device is applied to, thereby reducing an ergonomics of the device and causing a discomfort, thus, making a negative influence onto a human satisfaction level when performing massage procedures.

An application US2021031030 A1 dated Feb. 4, 2021 teaches a cosmetic device having a vibromassage effect, the device comprises a pair of shafts which are secured to a handle, a pair of rotation bodies which are rotatably coupled to the pair of the shafts, and a pair of vibration motors for transmitting a vibration to the pair of the rotation bodies, wherein the vibration motors are mounted on the shafts. Due to the fact that the vibration motors are not mounted within the handle, but within the elements of the shafts which are inserted into the rotation bodies, the vibration efficiency is increased and the vibration influence onto the operator's hand via the handle is minimized, thereby increasing a satisfaction level when using the device. A drawback of the proposed technical solution is that the use of the vibration motor as an electromechanical energy converter creates impact loads which act onto human tissues, thereby causing a risk of their injure, as well as it represents a source of a noise that creates a discomfort when using the proposed massage device.

A massage device according to a patent UA108725 dated May 25, 2015 has been taken as the closest analogue of the invention, the device comprises a housing with two coaxial shafts mounted therein on bearings, the shafts have a first and a second bipolar magnets and at least one massage nozzle, an immovable ferromagnetic ring having an inner surface with two electric winding coils and a third permanent magnet mounted on the inner surface, the third permanent magnet is arranged opposite to the first magnet, wherein a fourth permanent magnet is arranged on the inner surface of the ferromagnetic ring in a plane where the third magnet is arranged, the fourth permanent magnet is mounted opposite to the second magnet of the shaft, wherein the third and the fourth magnets have opposite polarities, and a transverse ring groove is provided in the middle of the ferromagnetic ring. Therefore, the proposed device provides a contactless and direct control of oscillations of the shafts with at least one massage nozzle by means of a so-called contactless magneto-electrical motor without using any transmission mechanism and mechanical limiters which enables to achieve a quiet operation and a smooth contact between the massage nozzle and a human skin without occurrence of excessive impact loads. A drawback of the proposed technical solution is that it does not enable to adjust an interaction force between the first and the third magnets, between the second and the fourth magnets, and between the coil and the first and the second magnets, respectively, which may cause an imbalance in the device operation that lies in that an uncontrolled rotation of the shafts will be possible, if there is an excessively strong interaction between the magnetic field of the coil and the first and the second magnets, or, conversely, there will be no or excessively weak rotation of the shafts, if there is an insufficient interaction force between the magnetic field of the coil and the first and the second magnets, and, thus, an ineffective operation of the massage device. Furthermore, the proposed massage device provides no adjustment of a frequency amplitude and a shape of inverter output impulses.

### SUMMARY OF THE INVENTION

An objective of the invention is to provide a vibration type massage device which could be structurally simple, reliable, ergonomic and configured to select an operation mode, which could provide a contactless control of oscillation parameters of shafts without using any mechanical limiters, thereby achieving a smooth and a noiseless operation of the device and enabling to achieve a technical effect that lies in that in view of an interaction between magnets which are arranged on the shafts, magnets which are arranged on an inner surface of a housing and coils which current impulses from an inverter are supplied to, periodic forces are formed on massage elements, and the periodic forces, in a single period of oscillations, smoothly rise, reach a maximum value and smoothly drop, and they may be adjusted depending on individual features of a human, while there is completely no negative vibration influence onto an operator's wrist and impact loads, and they avoid an uncontrolled circular rotation of the shafts, while at the same time, an operation efficiency of the claimed device is increased significantly.

According to a first embodiment of the claimed invention, the objective is resolved by a vibration type massage device comprising a housing (1) with an inner (2) and an outer (3) coaxial shafts mounted therein on bearings, the shafts have ends with an inner (4) and an outer (5) massage nozzles secured on the ends, and a first (6) and a second (7) cylindrical radially magnetized magnets are mounted on each of the shafts. A winding (8) is mounted on an inner surface of the housing (1), the winding comprises at least two coils having magnetic axes which are radial and offset relative to each other by more than 90 angular degrees, a third (9) and a fourth (10) radially magnetized magnets are secured between the coils of the winding (8) opposite to the first (6) and the second (7) cylindrical magnets, wherein the magnetic axes of the third (9) and the fourth (10) magnets are offset relative to each other by 180 angular degrees. The massage device further comprises an inverter that is connected to the coils and configured to smoothly or discretely change an amplitude, a frequency and a shape of output impulses by means of a control unit connected thereto, wherein an interaction force between the first and the third magnets, and between the second and the fourth magnets, is 5-30% more than an interaction force between the coil and the first and the second magnets, respectively, at a maximum amplitude of an output signal of the inverter.

Therefore, the claimed massage device enables a use of a contactless magneto-electric electro-mechanical converter of a reciprocating motion without using any transmission mechanisms and mechanical limiters, thereby providing a noiseless operation and a smooth contact between the massage nozzle of the device and a body surface without occurrence of any impact loads and without any negative vibration influence onto the operator's wrist or forearm. Therewith, the third (9) and the fourth (10) magnets act as magnetic springs which equalize deviation angles of the inner and the outer shafts with the massage nozzles relative to a stable balance position.

The structure of the massage device that implies the presence of the housing with the inner and the outer coaxial shafts which are concentrically mounted therein on the bearings, the shafts have ends with an inner and an outer massage nozzles secured on the ends, is mainly intended to massage large areas of the body such as, e.g., a back, buttocks or hips, using tangible vibration loads which act not only on top layers of the human skin, but also on subcutaneous tissues and muscles, thereby facilitating a fat layer breakdown, relieving a tension and painful feelings in human muscles.

Owing to the fact that the massage device utilizes the inverter connected to the coil, the inverter is configured to smoothly or discretely change the amplitude, frequency and shape of the output impulses, and is able to provide the interaction force between the first and the third magnets, and between the second and the fourth magnets, which is 5-30% more than the interaction force between the coil and the first and the second magnets, respectively, at the maximum amplitude of the output signal of the inverter, it is enabled to provide a balanced operation of the device and to avoid an uncontrolled rotation of the shafts, if there is an excessively strong interaction between the magnetic field of the coil and the first and the second magnets, or, conversely, to avoid a lack of or an excessively weak rotation of the shafts, if there is an insufficient interaction force between the magnetic field of the coil and the first and the second magnets, and, thus, to significantly increase the operation efficiency and stability of the claimed massage device. Therewith, owing to the fact that the inverter is configured to smoothly or discretely change the amplitude, frequency and shape of the output impulses by means of the control unit connected thereto, it is enabled to provide adjustable periodical forces which, in a single period, smoothly rise, reach a maximum value and smoothly drop, and to create the massage device having a wide range of operation modes depending on objectives and the human health.

Inventors have conducted a number of experiments related to the adjustment, by means of the output impulses of the inverter, of the interaction force between the coils and the first and the second magnets which are arranged on the shafts, and they have compared it to the interaction forces between the first and the second magnets and the third and the fourth magnets, respectively. It has been found that in order to ensure a reliable and a stable operation of the massage device, the interaction forces between the first and the third magnets and between the second and the fourth magnets must be 5-30% more than the interaction force between the coil and the first and the second magnets, respectively, at the maximum amplitude of the output signal of the inverter. In such a way, when the interaction force between the first and the third magnets and between the second and the fourth magnets is 35%, 40% and 45% more than the interaction force between the coil and the first and the second magnets, respectively, a weakening of mechanical rotation moments of the shafts with the massage nozzles has been observed, while an incidence of such cases was increasing with the increase of the interaction force between the first and the third magnets and between the second and the fourth magnets as compared to the interaction between the first and the second magnets and the coil, while when the interaction force between the first and the third magnets and between the second and the fourth magnets is 5, 10, 15% less than the interaction force between the first and the second magnets and the coil, an incidence of the uncontrolled circular rotation of the shafts was increasing due to an excessively strong interaction between the magnetic field of the coil and the first and the second magnets, wherein the incidence of these cases was increasing with the decrease of the interaction force between the first and the third magnets and between the second and the fourth magnets as compared to the interaction between the first and the second magnets and the coil.

In course of the experiments, the inventors also have adjusted the oscillation amplitude of the shafts of the device using mechanical limiters which appeared to be insufficiently effective and negatively affected the smoothness of the operation of the massage device due to formation of significant impact loads and a negative influence onto a nature of the loads which transmitted from the massage nozzles to the human body.

Therefore, in course of numerous experiments, it has been surprisingly found that the fact that the massage device utilizes the inverter connected to the coil, as well as the third and the fourth magnets which act as magnetic springs that equalize the deviation angles of the inner and the outer shafts with the massage nozzles relative to the stable balance position, is an unquestionable advantage as compared to use of the mechanical limiters in terms of the operation smoothness of the device and lack of impact loads.

Therewith, the housing of the massage device is made of a ferromagnetic material that is capable of reducing a resistance of passage of a magnetic flow excited by the first and the second magnets, thereby increasing a performance coefficient of the device.

Therewith, the housing of the massage device is made of a diamagnetic material having a ferromagnetic cylindrical insert on an inner surface.

Therewith, a frequency of oscillation of the inner shaft relative to the outer shaft is 1-100 Hz that enables performing the most physiological vibromassage that causes somatic and vegetative functions which are peculiar to human biological rhythms.

Therewith, a maximum angular deviation of the outer massage nozzle relative to the inner massage nozzle is at most 45 angular degrees that provides a stable operation of the device along with a highly effective massage.

Therewith, the massage nozzles are made in a form of spherical or rounded cone protrusions or alternating spherical and rounded cone protrusions. This shape provides no injuring action for the human body surface that is in contact with the massage nozzle, while use of the massage nozzles having different shapes both separately and in combination enables to perform the effective massage of various body parts.

Therewith, the massage nozzles comprise magnetic inserts which are arranged symmetrically relative to a rotation axis of the nozzles, thereby enabling to perform a magnetic therapy that implies a beneficial action of low frequency magnetic fields onto problematic areas of the body which, in combination with the mechanical vibromassage, expands functionalities of the claimed massage device.

Therewith, in one of exemplary embodiments of the invention, the control unit for controlling the change of the amplitude, frequency and shape of the output impulses of the inverter is mounted on the housing, thereby providing its compactness, ease of operation and mobility.

According to a second embodiment of the invention, a vibration type massage device comprises a housing (1) with a shaft (2) mounted therein on bearings (11), the shaft has ends with a massage nozzle (4) secured to one of the ends, a radially magnetized cylindrical magnet (6) is mounted in a central portion of the shaft (2), a winding (8) is mounted on an inner surface of the housing, the winding comprises at least two coils having magnetic axes which are radial and offset relative to each other by more than 90 angular degrees, a radially magnetized magnet (9) is secured between the coils of the winding (8) opposite to the radially magnetized cylindrical magnet (6). The massage device further comprises an inverter that is connected to the coils and configured to smoothly or discretely change an amplitude, a frequency and a shape of output impulses by means of a control unit connected thereto, wherein an interaction force between the radially magnetized cylindrical magnet (6) and the radially magnetized magnet (9) is 5-30% more than an interaction force between the cylindrical magnet (6) and the coil at a maximum amplitude of an output signal of the inverter.

Therefore, the claimed massage device enables a use of a contactless magneto-electric electro-mechanical reciprocating motion converter without using any transmission mechanisms and mechanical limiters, thereby providing a noiseless operation and a smooth contact between the massage nozzle of the device and a body surface without occurrence of any impact loads and without any negative vibration influence onto the operator's wrist or forearm. Therewith, the radially magnetized magnet (9) acts as a magnetic spring that equals a deviation angle of the shaft with the massage nozzle relative to a stable balance position.

The structure of the massage device that implies the housing having the shaft mounted on the bearings, the shaft has ends with the massage nozzle secured to one of the ends, is characterized by a relatively low weight and compact dimensions, and it is intended mainly to massage sensitive areas of the body such as, e.g., a face or a neck, using insignificant vibration loads which act mainly at top layers of a human skin, thereby improving a blood and lymph circulation, facilitating the human skin cleansing and avoiding their injuring and occurrence of unpleasant or painful feelings.

Owing to the fact that the massage device utilizes the inverter connected to the coil, the inverter is configured to smoothly or discretely change the amplitude, frequency and shape of the output impulses, and is able to provide the interaction force between the radially magnetized cylindrical magnet (6) and the radially magnetized magnet (9) that is 5-30% more than the interaction force between the cylindrical magnet (6) and the coil at the maximum amplitude of the output signal of the inverter, it is enabled to provide a balanced operation of the device and to avoid an uncontrolled rotation of the shaft, if there is an excessively strong interaction between the magnetic field of the coil and the cylindrical magnet (6), or, conversely, to avoid a lack of or an excessively weak rotation of the shaft, if there is an insufficient interaction force between the magnetic field of the coil and the cylindrical magnet (6), and, thus, to significantly increase the operation efficiency and stability of the claimed massage device. Therewith, in view of the fact that the inverter is configured to smoothly or discretely change the amplitude, frequency and shape of the output impulses by means of the control unit connected thereto, it is enabled to provide adjustable periodical forces which, in a single period, smoothly rise, reach a maximum value and smoothly drop, and to create the massage device having a wide range of operation modes depending on objectives and the human health.

Inventors have conducted a number of experiments related to the adjustment, by means of the output impulses of the inverter, of the interaction force between the coils and the cylindrical magnet (6) arranged on the shaft, and they have compared it to the interaction forces of the radially magnetized cylindrical magnet (6) and the radially magnetized magnet (9). It has been found that in order to ensure the reliable and stable operation of the massage device, the interaction forces between the radially magnetized cylindrical magnet (6) and the radially magnetized magnet (9) must be 5-30% more than the interaction force between the coil and the radially magnetized cylindrical magnet (6) at the maximum amplitude of the output signal of the inverter. In such a way, when the interaction force between the radially magnetized cylindrical magnet (6) and the radially magnetized magnet (9) is 35%, 40% and 45% more than the interaction force between the coil and the radially magnetized cylindrical magnet (6), a weakening of mechanical rotation moments of the shaft with the massage nozzle has been observed, while an incidence of such cases was increasing with the increase of the interaction force between the radially magnetized cylindrical magnet (6) and the radially magnetized magnet (9) as compared to the interaction between the radially magnetized cylindrical magnet (6) and the coil, while when the interaction force between the radially magnetized cylindrical magnet (6) and the radially magnetized magnet (9) is 5, 10, 15% less than the interaction force between the radially magnetized cylindrical magnet (6) and the coil, an incidence of the uncontrolled circular rotation of the shaft was increasing due to excessively strong interaction between the magnetic field of the coil and the radially magnetized cylindrical magnet (6), wherein the incidence of these cases was increasing with the decrease of the interaction force between the radially magnetized cylindrical magnet (6) and the radially magnetized magnet (9) as compared to the interaction between the radially magnetized cylindrical magnet (6) and the coil.

In course of the experiments, the inventors also have adjusted the oscillation amplitude of the shaft of the device using mechanical limiters which appeared to be insufficiently effective and negatively affected the smoothness of the operation of the massage device due to formation of significant impact loads and a negative influence onto a nature of the loads which transmitted from the massage nozzle to the human body.

Therefore, in course of numerous experiments, it has been surprisingly found that the fact that the massage device utilizes the inverter connected to the coil, as well as the radially magnetized magnet (9) that acts as a magnetic spring that equalizes a deviation angle with the massage nozzle relative to the stable balance position, is an unquestionable advantage as compared to use of the mechanical limiters in terms of the operation smoothness of the device and lack of impact loads.

Therewith, the housing of the massage device is made of a ferromagnetic material that is capable of reducing a resistance of passage of a magnetic flow excited by the radially magnetized cylindrical magnet mounted on the shaft, thereby increasing a performance coefficient of the device.

Therewith, the housing of the massage device is made of a diamagnetic material having a ferromagnetic cylindrical insert on an inner surface.

Therewith, the massage nozzle is made in a form of spherical or rounded cone protrusions. This shape provides no injuring action for the human body surface that is in contact with the massage nozzle, while use of the massage nozzles having different shapes enables to perform the effective massage of various body parts.

Therewith, according to one of exemplary embodiments of the invention, the massage nozzle comprises at least one magnetic insert.

Therewith, in another exemplary embodiment of the invention, the massage nozzle comprises at least two magnetic inserts which are arranged symmetrically relative to a rotation axis of the nozzle, thereby enabling to perform a magnetic therapy that implies a beneficial action of low frequency magnetic fields onto problematic areas of the body which, in combination with the mechanical vibromassage, expands functionalities of the claimed massage device.

Therewith, in one of exemplary embodiments of the invention, the control unit for controlling the change of the amplitude, frequency and shape of the output impulses of the inverter is mounted on the housing, thereby providing its compactness, ease of operation and mobility.

### BRIEF DESCRIPTION OF THE DRAWINGS

A possibility of implementation of the invention is illustrated by the drawings, which show the following.

FIG. 1 illustrates a general view of the massage device with main structural elements, according to the first embodiment of the claimed invention;

FIG. 2 illustrates a general view of the massage device with main structural elements, according to the second embodiment of the claimed invention;

FIG. 3 is a block diagram that illustrates a general operation principle of the massage device, according to the embodiments of the claimed invention.

The illustrative drawings that explain the claimed invention as well as the mentioned particular exemplary embodiments of the vibration type massage device are in no way intended to limit the scope of rights appended hereto, but to explain the essence of the invention.

### IMPLEMENTATION OF THE INVENTION

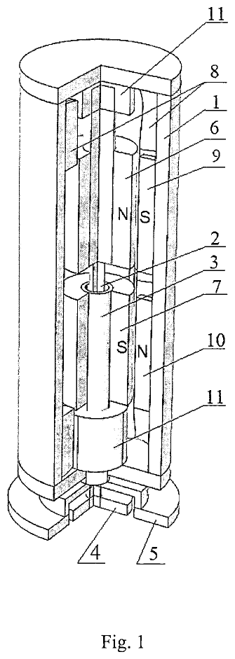

FIG. 1 illustrates a general view of the massage device with main structural elements, according to the first embodiment of the claimed invention. A vibration type massage device comprises a housing (1) with an inner (2) and an outer (3) coaxial shafts mounted therein on bearings, the shafts have ends with an inner (4) and an outer (5) massage nozzles secured on the ends, and a first (6) and a second (7) radially magnetized cylindrical magnets are mounted on each of the shafts. A winding (8) is mounted on an inner surface of the housing, the winding comprises at least two coils having magnetic axes which are radial and offset relative to each other by more than 90 angular degrees, a third (9) and a fourth (10) radially magnetized magnets are secured between the coils of the winding (8) opposite to the first and the second cylindrical magnets, wherein magnetic axes of the third and the fourth magnets are offset relative to each other by 180 angular degrees. The inner (2) and the outer (3) coaxial shafts are mounted on bearings (11).

The massage device further comprises an inverter (not illustrated in the drawings) that may be provided as a separate unit or may be mounted on the housing, connected to the coils and configured to smoothly or discretely change an amplitude, a frequency and a shape of output impulses, wherein an interaction force between the first and the third magnets and the second and the fourth magnets is 5-30% more than an interaction force between the coil and the first and the second magnets, respectively, at a maximum amplitude of the output signal of the inverter.

An adjustment of the interaction force between the magnets arranged on the shafts and the magnetic field of the coils that is performed by adjusting the output impulses that come from the inverter enables to provide a balanced operation of the device and to avoid an uncontrolled rotation of the shafts, if there is an excessively strong interaction between the magnetic field of the coil and the first and the second magnets, or, conversely, to avoid a lack of or an excessively weak rotation of the shafts, if there is an insufficient interaction force between the magnetic field of the coil and the first and the second magnets, and, thus, to significantly increase the operation efficiency and stability of the claimed massage device.

The massage device operates according to the following principle: until the winding (8) is not connected to power sources (to the inverter), the first cylindrical magnet (6), due to its interaction with the third magnet (9), together with the inner shaft (2) and the inner massage nozzle (4), and the second cylindrical magnet (7), due to its interaction with the fourth magnet (10), together with the outer shaft (3) and the outer massage nozzle (5), take a stable balance position, as illustrated in FIG. 1, wherein poles of the magnets (6) and (7) are arranged opposite to an active part of the winding (8) coils. When the winding (8) is connected to an alternating current source (to the inverter), a variable electromagnetic field will be formed, and the variable electromagnetic field will interact with the first (6) and the second (7) magnets. Since the winding (8) generates a magnetic field that is variable in time with a frequency of the alternating current of the inverter, the magnets (6) and (7) will deviate around a longitudinal axis of the shafts (2) and (3) from the stable balance position with the frequency of the inverter towards different directions. Therewith, the third (9) and the fourth (10) magnets which are arranged between the coils of the winding (8) act as magnetic springs and ensure a smooth operation of the massage device, thereby neutralizing impact loads which could appear when using, e.g., mechanical limiters. A negative reaction moment acts on the housing of the device, and the negative reaction moment is a sum of mechanical moments of the magnets (6) and (7), and since these moments have the same value, but act in opposite directions, any vibration of the housing is avoided.

The structure of the massage device having the inner (2) and the outer (3) coaxial shafts having ends with the inner (4) and the outer (5) massage nozzles secured on the ends, according to the first embodiment of the invention, is mainly intended to massage large areas of the body such as, e.g., a back, buttocks or hips, using tangible vibration loads which act not only on top layers of the human skin, but also on subcutaneous tissues and muscles, thereby facilitating a fat layer breakdown, relieving a tension and painful feelings in human muscles.

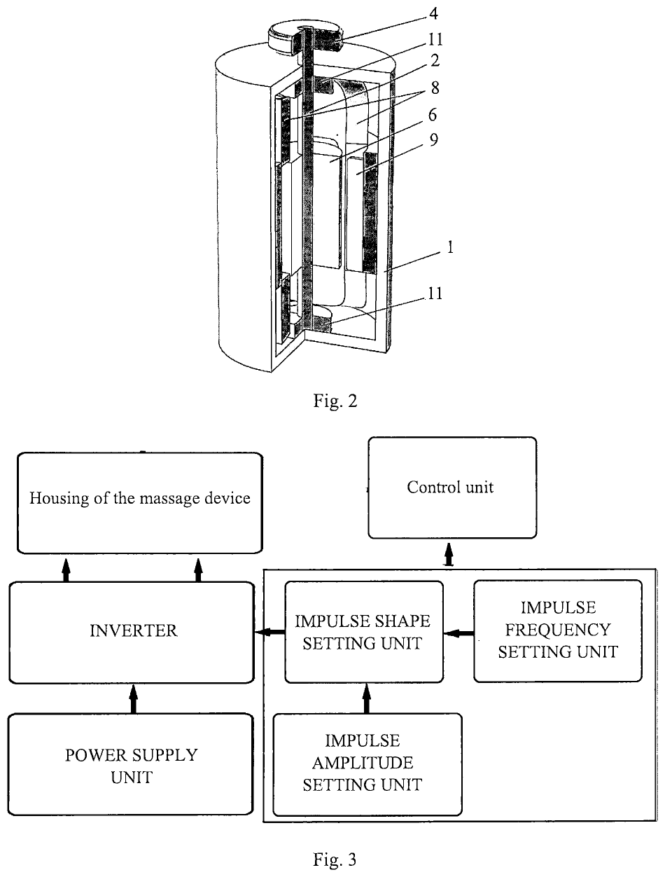

FIG. 2 illustrates a general view of the massage device with main structural elements, according to the second embodiment of the claimed invention. A vibration type massage device comprises a housing (1) with a shaft (2) mounted on bearings (11), the shaft has ends with a massage nozzle (4) secured to one of the ends, a radially magnetized cylindrical magnet (6) is mounted in a central portion of the shaft (2), a winding (8) is mounted on an inner surface of the housing, the winding comprises at least two coils having magnetic axes which are radial and offset relative to each other by more than 90 angular degrees, a radially magnetized magnet (9) is secured between the coils of the winding (8) opposite to the radially magnetized cylindrical magnet (6).

The massage device further comprises an inverter (not illustrated in the drawings) that may be provided as a separate unit or may be mounted on the housing, connected to the coils and configured to smoothly or discretely change an amplitude, a frequency and a shape of output impulses, wherein an interaction force between the radially magnetized cylindrical magnet (6) and the radially magnetized magnet (9) is 5-30% more than an interaction force between the cylindrical magnet (6) and the coil, at a maximum amplitude of the output signal of the inverter.

An adjustment of the interaction force between the cylindrical magnet arranged on the shaft and the magnetic field of the coils that is performed by adjusting the output impulses that come from the inverter enables to provide a balanced operation of the device and to avoid an uncontrolled rotation of the shaft, if there is an excessively strong interaction between the magnetic field of the coil and the cylindrical magnet arranged on the shaft, or, conversely, to avoid a lack of or an excessively weak rotation of the shaft, if there is an insufficient interaction force between the magnetic field of the coil and the cylindrical magnet arranged on the shaft, and, thus, to significantly increase the operation efficiency and stability of the claimed massage device.

The massage device operates according to the following principle: until the winding (8) is not connected to power sources (to the inverter), the cylindrical magnet (6), due to its interaction with the radially magnetized magnet (9), together with the shaft (2) and the massage nozzle (4), take a stable balance position as illustrated in FIG. 2, wherein poles of the magnet (6) are arranged opposite to an active part of the winding (8) coils. When the winding (8) is connected to an alternating current source (to the inverter), a variable electromagnetic field will be formed, and the variable electromagnetic field will interact with the cylindrical magnet (6). Since the winding (8) generates a magnetic field that is variable in time with a frequency of the alternating current of the inverter, the magnet (6) will deviate around a longitudinal axis of the shaft (2) from the stable balance position with the frequency of the inverter towards different directions. Therewith, the magnet (9) that is arranged between the coils of the winding (8) acts as a magnetic spring and ensures a smooth operation of the massage device, thereby neutralizing impact loads which could appear when using, e.g., mechanical limiters.

The structure of the massage device that implies the housing having the shaft mounted on the bearings, the shaft has ends with the massage nozzle secured on one of the ends, according to the second embodiment of the invention, is characterized by a relatively low weight and compact dimensions, and it is intended mainly to massage sensitive areas of the body such as, e.g., a face or a neck, using insignificant vibration loads which act mainly at top layers of a human skin, thereby improving a blood and lymph circulation, facilitating the human skin cleansing and avoiding their injuring and occurrence of unpleasant or painful feelings.

FIG. 3 is a block diagram that illustrates a general operation principle of the massage device, according to the embodiments of the claimed invention. The operation principle is as follows: an operator sets given shape, frequency and amplitude of the output signal of the inverter by using adjustment tools which are installed on a control unit connected to the inverter. The control unit consists of an impulse shape setting unit, an impulse frequency setting unit and an impulse amplitude setting unit. Potentiometers, button switches, digital potentiometers, a keyboard etc. may be used as the adjustment tools. The inverter converts a constant voltage of a power supply unit into a variable electrical signal having those shape, frequency and amplitude which correspond to the ones set by the control unit. When the winding of the housing of the massage device is connected to an output of the inverter, an alternating current will flow along the winding, thereby creating a variable electromagnetic field of the winding that interacts with two cylindrical magnets which are arranged on shafts of the massage device, according to the first embodiment of the invention, or with one cylindrical magnet that is arranged on the shaft of the massage device, according to the second embodiment of the invention. Since the winding generates a magnetic field that is variable in time with a frequency of the alternating current of the inverter, the cylindrical magnets will deviate around a longitudinal axis of the shaft, which they are mounted on, from the stable balance position with the frequency of the inverter towards different directions.

Therewith, in view of the fact that the inverter is configured to smoothly or discretely change the amplitude, frequency and shape of the output impulses by means of the control unit, it is enabled to provide adjustable periodical forces which, in a single period, smoothly rise, reach a maximum value and smoothly drop, and to create the massage device having a wide range of operation modes depending on objectives and the human health.

Therefore, the claimed invention enables to provide the structurally simple, reliable, ergonomic vibration type massage device that is configured to select the operation mode depending on objectives of the massage and the human health, and which, owing to the adjustment of the interaction force between the magnets arranged on the shafts and the magnetic field of the coils by means of the inverter, enables to provide the balanced operation of the device and to avoid cases of the uncontrolled circular rotation of the shafts or, conversely, of the lack or the excessively weak rotation of the shafts, thereby increasing the efficiency and stability of the operation of the claimed massage device.

Therewith, the above-described exemplary embodiments of the invention should be used as an illustration only and should not limit the scope of the invention. Obvious modifications of the embodiment of the invention may be easily made by persons skilled in this field of art without falling beyond the essence thereof.

1. A vibration type massage device comprising a housing (1) with an inner (2) and an outer (3) coaxial shafts mounted therein on bearings, the shafts having ends with an inner (4) and an outer (5) massage nozzles secured on the ends, respectively, and first (6) and second (7) cylindrical radially magnetized magnets are mounted on each of the shafts, a winding (8) is mounted on an inner surface of the housing (1), the winding comprises at least two coils having magnetic axes that are radial and offset relative to each other by more than 90 angular degrees, third (9) and fourth (10) radially magnetized magnets are secured between the coils of the winding (8) opposite to the first and the second cylindrical magnets, wherein the magnetic axes of the third and the fourth magnets are offset relative to each other by 180 angular degrees, wherein the device comprises an inverter that is connected to the coils and configured to smoothly or discretely change an amplitude, a frequency, and a shape of output impulses by a control unit connected thereto, and an interaction force between the first and the third magnets, and between the second and the fourth magnets, is 5-30% more than an interaction force between the coil and the first and the second magnets, respectively, at a maximum amplitude of an output signal of the inverter.

2. The vibration type massage device according to claim 1, wherein the housing comprises a ferromagnetic material.

3. The vibration type massage device according to claim 1, wherein the housing comprises a diamagnetic material having a ferromagnetic cylindrical insert on an inner surface.

4. The vibration type massage device according to claim 1, wherein a frequency of oscillations of the inner shaft relative to the outer shaft is 1-100 Hz.

5. The vibration type massage device according to claim 1, wherein a maximum angular deviation of the outer massage nozzle relative to the inner massage nozzle is at most 45 angular degrees.

6. The vibration type massage device according to claim 1, wherein the massage nozzles are made in a form of spherical or rounded cone or alternating spherical and rounded cone protrusions.

7. The vibration type massage device according to claim 1, wherein the massage nozzles comprise magnetic inserts that are arranged symmetrically relative to a rotation axis of the nozzles.

8. The vibration type massage device according to claim 1, wherein the control unit is mounted on the housing.

9. A vibration type massage device comprising a housing (1) with a shaft (2) mounted therein on bearings (11), the shaft having ends with a massage nozzle (4) secured to one of the ends, a radially magnetized cylindrical magnet (6) is mounted in a central portion of the shaft (2), a winding (8) is mounted on an inner surface of the housing, the winding comprises at least two coils having magnetic axes that are radial and offset relative to each other by more than 90 angular degrees, a radially magnetized magnet (9) is secured between the coils of the winding (8) opposite to the radially magnetized cylindrical magnet (6), wherein the device comprises an inverter that is connected to the coils and configured to smoothly or discretely change an amplitude, a frequency, and a shape of output impulses by a control unit connected thereto, wherein an interaction force between the radially magnetized cylindrical magnet (6) and the radially magnetized magnet (9) is 5-30% more than an interaction force between the cylindrical magnet (6) and the coil at a maximum amplitude of an output signal of the inverter.

10. The vibration type massage device according to claim 9, wherein the housing comprises a ferromagnetic material.

11. The vibration type massage device according to claim 9, wherein the housing comprises a diamagnetic material having a ferromagnetic cylindrical insert on an inner surface.

12. The vibration type massage device according to claim 9, wherein the massage nozzle is made in a form of spherical or rounded cone protrusions.

13. The vibration type massage device according to claim 9, wherein the massage nozzle comprises at least one magnetic insert.

14. The vibration type massage device according to claim 9, wherein the massage nozzle comprises at least two magnetic inserts that are arranged symmetrically relative to a rotation axis of the nozzle.

15. The massage device according to claim 9, wherein the control unit is mounted on the housing.
